(19) United States
(12) Patent Application Publication
(10) Pub. No.: US 2025/0141522 A1
(43) Pub. Date: May 1, 2025

(54) METHOD FOR CHANNEL QUALITY INDICATOR CALCULATION, TERMINAL DEVICE, AND NETWORK DEVICE

(71) Applicant: SPREADTRUM COMMUNICATIONS (SHANGHAI) CO., LTD., Shanghai (CN)

(72) Inventors: Huayu ZHOU, Shanghai (CN); Dawei MA, Shanghai (CN); Mimi CHEN, Shanghai (CN); Zhengang PAN, Shanghai (CN)

(21) Appl. No.: 18/726,017

(22) PCT Filed: Dec. 26, 2022
(86) PCT No.: PCT/CN2022/141802

§ 371 Date: Jul. 1, 2024

(30) Foreign Application Priority Data
Dec. 31, 2021 (CN) 202111676488.6

(51) Int. Cl. H04B 7/06; H04B 17/309; H04W 24/10

(52) U.S. Cl. CPC H04B 7/0632; H04B 7/0626; H04B 17/309; H04W 24/10

(57) ABSTRACT

A method for channel quality indicator (CQI) calculation, a terminal device, and a network device are disclosed. The method for CQI calculation includes calculating a CQI.

CROSS-REFERENCE TO RELATED APPLICATION(S)

This application is a National Stage of International Application No. PCT/CN2022/141802, filed Dec. 26, 2022, which claims priority to Chinese Patent Application No. 202111676488.6, filed Dec. 31, 2021, both of which are incorporated herein by reference in their entireties.

### TECHNICAL FIELD

Embodiments of the disclosure relate to the field of communication technologies, and in particular, to a method for channel quality indicator (CQI) calculation, a terminal device, and a network device.

### BACKGROUND

In the evolution of wireless communication systems, people are always exploring use of convergence between artificial intelligence (AI) and physical layers. AI may include machine learning (ML), deep learning (DL), etc. Introduction of AI in physical layer algorithms can solve some problems that are difficult to be solved with conventional modeling approaches, such as some nonlinear problems, too complex parameters, etc. With AI algorithms, conventional modeling approaches can be bypassed, and some problem solving patterns can be established through a large amount of data training. With the maturity of AI algorithms and the maturity of hardware suitable for AI algorithms, introduction of AI in physical layer algorithms has attracted more and more attention.

As a typical application, AI may be introduced to channel state information (CSI) feedback. In a scenario where AI is introduced to CSI feedback, a terminal device can directly feed back (or report) a precoding matrix or directly feed back a channel matrix through an AI neural network (“AI model” for short), so as to replace codebook-based feedback. The AI model may include a convolutional neural network (CNN), a deep neural network (DNN), etc. Direct feedback of a precoding matrix or a channel matrix may also be referred to as explicit CSI feedback.

In some scenarios, compared with codebook-based feedback, direct feedback of a precoding matrix or a channel matrix can provide more information such as magnitude information (an eigen vector does not indicate magnitude information), and is more suitable for multi-user multi-input multi-output (MU-MIMO). After introduction of direct feedback of a precoding matrix or a channel matrix to a CSI feedback framework (an overall feedback mechanism including a channel quality indicator (CQI), a precoding matrix indicator (PMI), a rank indicator (RI), a CSI reference signal resource indicator (CRI (or synchronization signal/physical broadcast channel (SS/PBCH) block resource indicator (SSBRI)), etc.), the terminal device no longer adopts codebook-based feedback, and thus there may be a certain impact on the CSI feedback framework. How to cope with the impact has become an urgent problem to be solved.

### SUMMARY

In a first aspect, a method for channel quality indicator (CQI) calculation is provided. The method includes calculating a CQI.

In a second aspect, a terminal device is provided. The terminal includes a transceiver, a processor coupled to the transceiver, and a memory storing a computer program which, when executed by the processor, causes the terminal device to calculate a CQI.

In a third aspect, a network device is provided. The network device includes a transceiver, a processor coupled to the transceiver, and a memory storing a computer program which, when executed by the processor, causes the network device to acquire a CQI via the transceiver.

### BRIEF DESCRIPTION OF THE DRAWINGS

In order to illustrate technical solutions in embodiments of the disclosure more clearly, the following will give a brief introduction to accompanying drawings required for describing embodiments or the related art.

FIG. 1 is a schematic diagram illustrating an architecture of a wireless communication system in embodiments of the disclosure.

FIG. 2 is a schematic flow chart illustrating a method for channel quality indicator (CQI) calculation in embodiments of the disclosure.

FIG. 3 is a schematic flow chart illustrating a method for CQI acquisition in embodiments of the disclosure.

FIG. 4 is a block diagram illustrating functional units of an apparatus for CQI calculation in embodiments of the disclosure.

FIG. 5 is a block diagram illustrating functional units of an apparatus for CQI acquisition in embodiments of the disclosure.

FIG. 6 is a schematic structural diagram illustrating a terminal device in embodiments of the disclosure.

FIG. 7 is a schematic structural diagram illustrating a network device in embodiments of the disclosure.

### DETAILED DESCRIPTION

In order to facilitate better understanding of technical solutions of the disclosure by those skilled in the art, the following will illustrate the technical solutions of embodiments of the disclosure with reference to accompanying drawings of embodiments of the disclosure. Apparently, embodiments illustrated herein are some, rather than all, of the disclosure. Based on the embodiments of the disclosure, all other embodiments obtained by those of ordinary skill in the art without creative effort shall fall within the protection scope of the disclosure.

It may be understood that the terms “first”, “second”, and the like involved in embodiments of the disclosure are used to distinguish different objects rather than describe a particular order. In addition, the terms “include”, “comprise”, and “have” as well as variations thereof are intended to cover non-exclusive inclusion. For example, a process, method, software, product, or device including a series of steps or units is not limited to the listed steps or units, on the contrary, it can include other steps or units that are not listed; or other steps or units inherent to the process, method, product, or device can be included either.

The term “embodiment” involved herein means that a particular feature, structure, or feature described in conjunction with the embodiments may be contained in at least one embodiment of the disclosure. The phrase appearing in various places in the specification does not necessarily refer to the same embodiment, nor does it refer to an independent or alternative embodiment that is mutually exclusive with other embodiments. It is explicitly and implicitly understood by those skilled in the art that the embodiments described herein may be combined with other embodiments.

The “at least one” in embodiments of the disclosure refers to one or more, and “plurality of” or “multiple” refers to two or more.

The term “and/or” in embodiments of the disclosure illustrates an association relationship of associated objects, indicating that three relationships can exist, for example, A and/or B may mean A alone, both A and B exist, and B alone. A and B each may be a singular from or a plural form. The character “/” herein may indicate that the associated objects are in an “or” relationship. In addition, the symbol “/” may represent a division sign, i.e., perform a division operation.

The term “at least one (item) of” or the like in embodiments of the disclosure refers to any combination of these items, including any combination of a single item or multiple items. For example, at least one (item) of a, b, or c can represent the following seven cases: a; b; c; a and b; a and c; b and c; a, b, and c. a, b, and c each may be an element or a set including one or more elements.

It needs to be noted that, the “connection” appeared in embodiments of the disclosure refers to various manners of connection, such as direct connection or indirect connection, so as to implement communication between devices, which is not limited herein. The terms “network” and “system” appeared in embodiments of the disclosure express the same concept, and a communication system is a communication network.

The technical solutions of embodiments of the disclosure are applicable to various wireless communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (WiFi), a 6th-generation (6G) communication system, or other communication systems, etc.

It may be noted that a conventional wireless communication system generally supports a limited quantity of connections and therefore is easy to implement. However, with development of communication technology, a wireless communication system will not only support conventional wireless communication systems but also support, for example, device to device (D2D) communication, machine to machine (M2M) communication, machine type communication (MTC), vehicle to vehicle (V2V) communication, vehicle to everything (V2X) communication, a narrow band internet of things (NB-IoT), etc. Therefore, the technical solutions in embodiments of the disclosure can also be applied to the wireless communication systems above.

Optionally, the wireless communication system in embodiments of the disclosure may be applied to a beamforming scenario, a carrier aggregation (CA) scenario, a dual connectivity (DC) scenario, a standalone (SA) deployment scenario, etc.

Optionally, the wireless communication system in embodiments of the disclosure can be applied to an unlicensed spectrum, where the unlicensed spectrum can also be regarded as a shared spectrum. Alternatively, the communication system in embodiments of the disclosure can also be applied to a licensed spectrum, where the licensed spectrum can also be regarded as an unshared spectrum.

Since each embodiment is described in conjunction with a terminal device and a network device in embodiments of the disclosure, the following provides a specific illustration of involved terminal devices and network devices.

Specifically, the terminal device may be a user equipment (UE), a remote UE, a relay UE, an access terminal, a subscriber unit, a subscriber station, a mobile station, a remote station, a mobile device, a user terminal, a smart terminal, a wireless communication device, a user agent, a user apparatus, etc. It may be noted that relay UE is a terminal device that can provide relay forwarding services to other terminal devices (including remote UEs). In addition, the terminal device may also be a cellular radio telephone, a cordless telephone, a session initiation protocol (SIP) telephone, a wireless local loop (WLL) station, a personal digital assistant (PDA), a device with wireless communication functions such as a handheld device, a computing device, or other processing devices coupled with a wireless modem, an in-vehicle device, a wearable device, and a terminal device in a next-generation communication system (for example, an NR communication system or a 6G communication system), a terminal device in a future evolved public land mobile network (PLMN), etc., which is not specifically limited herein

Furthermore, the terminal device may be deployed on land, which includes indoor or outdoor, handheld, wearable, or in-vehicle. The terminal device may also be deployed on water (such as ships, etc.). The terminal device may also be deployed in the air (such as airplanes, balloons, satellites, etc.).

Furthermore, the terminal device may be a mobile phone, a pad, a computer with wireless transceiver functions, a virtual reality (VR) terminal device, an augmented reality (AR) terminal device, a wireless terminal device in industrial control, a wireless terminal device in self driving, a wireless terminal device in remote medicine, a wireless terminal device in smart grid, a wireless terminal device in transportation safety, a wireless terminal device in smart city, or a wireless terminal device in smart home, etc.

Specifically, the network device may be a device used for communication with terminal devices, responsible for radio resource management (RRM), quality of service (QOS) management, data compression and encryption, data transmission and reception at the air interface side. The network device may be a base station (BS) in the communication system or a device deployed in a radio access network (RAN) to provide wireless communication functions, for example, a base transceiver station (BTS) in the GSM or CDMA communication system, a node B (NB) in the WCDMA communication system, an evolved node B (eNB or eNodeB) in the LTE communication system, a next generation evolved node B (ng-eNB) in the NR communication system, a next generation node B (gNB) in the NR communication system, a master node (MN) in a dual link architecture, or a second node or a secondary node (SN) in the dual link architecture, which is not specifically limited herein.

Furthermore, the network device may also be other devices in a core network (CN), such as access and mobility management function (AMF), user plan function (UPF), etc. The network device may also be an access point (AP) in the WLAN, a relay station, a communication device in the future evolved PLMN, a communication device in the NTN, etc.

Furthermore, the network device may include an apparatus with a function of providing wireless communication to a terminal device, such as a chip system, etc. Exemplarily, the chip system may include a chip and other discrete devices.

Furthermore, the network device can also communicate with an internet protocol (IP) network, for example, the internet, a private IP network, or other data networks.

It needs to be noted that, in some deployments, the network device may be an independent node to implement all functions of the above BS. The network device may include a centralized unit (CU) and a distributed unit (DU), such as a gNB-CU and a gNB-DU. The network device may further include an active antenna unit (AAU). The CU implements some functions of the network device, and the DU implements some other functions of the network device. For example, the CU is responsible for processing non-real-time protocols and services, and implements functions of a radio resource control (RRC) layer, functions of a service data adaptation protocol (SDAP) layer, and functions of a packet data convergence protocol (PDCP) layer. The DU is responsible for processing physical (PHY) layer protocols and real-time services, and implements functions of a radio link control (RLC) layer, functions of a medium access control (MAC) layer, and functions of a PHY layer. In addition, the AAU implements some PHY layer processing functions, radio frequency processing functions, and active-antenna related functions. Since RRC layer information will eventually become PHY layer information, or is transformed from PHY layer information, in this network deployment, it may be considered that higher layer signaling (such as RRC layer signaling) is transmitted by the DU, or transmitted by both the DU and the AAU. It may be understood that, the network device may include at least one of the CU, the DU, or the AAU. In addition, the CU may be categorized as a network device in the RAN, or may be categorized as a network device in the CN, which is not specifically limited herein.

Furthermore, the network device may be mobile. For example, the network device may be a mobile device. Optionally, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station deployed on land or water.

Furthermore, the network device can provide services to a cell, and terminal devices within the cell can communicate with the network device over a transmission resource (e.g., a spectrum resource). The cell may include a macro cell, a small cell, a metro cell, a micro cell, a pico cell, a femto cell, etc.

With reference to the above illustrations, the following exemplarily illustrates a wireless communication system in embodiments of the disclosure.

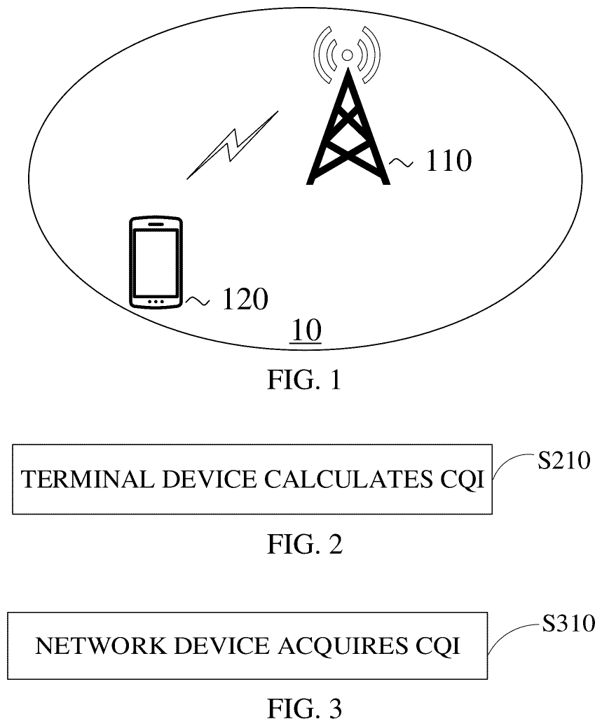

Exemplarily, for the wireless communication system in embodiments of the disclosure, reference can be made to FIG. 1. The wireless communication system 10 may include a network device 110 and a terminal device 120. The network device 110 may communicate with the terminal device 120. Meanwhile, the network device 110 can provide a communication coverage for a specific geographic area and communicate with terminal devices 120 in the coverage area.

Optionally, the wireless communication system 10 may further include multiple network devices and the other number of terminal devices that may be included in a coverage range of each of the multiple network devices, which will not be limited in embodiments of the disclosure.

Optionally, the wireless communication system 10 may further include a network controller, a mobility management entity, and other network entities, which will not be limited in embodiments of the disclosure.

Optionally, in the wireless communication system 10, communication between the network device and the terminal device and communication between terminal devices may be wireless communication or wired communication, which will not be limited in embodiments of the disclosure.

The following will introduce relevant content involved in embodiments of the disclosure.

### 1. Multiple Input Multiple Output (MIMO)

MIMO technology has many advantages such as high spectral efficiency and high system capacity. An MIMO signal model may be expressed as: r=Hs+n, where r represents a received signal vector, H represents an MIMO channel matrix, s represents a transmitted signal vector, and n represents an additive noise vector.

In a precoding manner, a transmitter can optimize a spatial characteristic of a transmitted signal according to a channel matrix, to enable a spatial distribution characteristic of the transmitted signal to match the channel matrix, and thus the degree of dependence on a receiver algorithm can be effectively reduced.

Precoding can be performed in a linear manner or a nonlinear manner. Due to complexity and other causes, generally, only linear precoding is considered in the current wireless communication system. After precoding, the MIMO signal model may be expressed as: r=HWs+n, where W represents a precoding matrix.

### 2. Channel State Information (CSI) Feedback or Reporting

The protocol standards specified by 3rd generation partnership project (3GPP) have conducted related research on CSI. The CSI is used by a terminal device to feed back downlink channel quality to a network device, so that the network device can select a suitable modulation and coding scheme (MCS) for downlink data transmission, and thus a block error rate (BLER) of downlink data transmission can be reduced, and corresponding beam management, mobility management, adaptation tracking, rate matching, and other processing can be performed.

CSI feedback may include at least one of: a CSI reference signal resource indicator (CRI (or SSBRI)), a rank indicator (RI), a precoding matrix indicator (PMI), a channel quality indicator (CQI), a synchronization signal/physical broadcast channel (SS/PBCH) block resource indicator (SSBRI), or a layer indicator (LI).

The CRI may represent a CSI-reference signal (RS) resource set recommended (or selected) by the terminal device, and the SSBRI may represent an SS/PBCH block (SSB) resource set recommended (or selected) by the terminal device. The CSI-RS (or SSB) resource set may represent a beam direction or an antenna direction.

The CQI can indicate whether current quality of a wireless channel fed back to the network device by the terminal device is good. The terminal device needs to calculate a CQI and report a maximum CQI index. The CQI index may enable the terminal device to receive a physical downlink shared channel (PDSCH) transport block with a transport block error probability not exceeding 0.1. The PDSCH transport block has a modulation format, a target code rate, and a transport block size. The PDSCH transport block corresponds to the CQI index and occupies a CSI reference resource(s).

Under an additive white Gaussian noise (AWGN) channel, a reported CQI is in a range of ±1 of a reported median 90% of a time. If a PDSCH BLER using a transport format indicated by median CQI is less than or equal to 0.1, a PDSCH BLER using a transport format indicated by median CQI+1 is greater than 0.1. If the PDSCH BLER using the transport format indicated by median CQI is greater than 0.1, a PDSCH BLER using a transport format indicated by median CQI−1 is less than or equal to 0.1.

Under a fading channel, the CQI in a set of {median CQI−1, median CQI, median CQI+1} may be reported at least α% of a time (α is a preset value). An amount of a throughput corresponding to a transport format indicated by each reported wideband CQI index and indicated by a wideband CQI median is greater than γ(γ is a preset value). An average PDSCH BLER using the transport format indicated by each reported wideband CQI is greater than or equal to 0.01.

The RI may indicate a layer number recommended (or selected) by the terminal device, and a codebook may be determined according to a layer number. Each layer number corresponds to a codebook, and a codebook consists of one or more codewords, for example, there may be a codebook corresponding to a layer number of 2 or a codebook corresponding to a layer number of 1. In addition, in the MIMO technology, the layer number may indicate the number of transmission links between a transmitting terminal and a receiving terminal.

The PMI may indicate an index of a codeword in a codebook recommended (or selected) by the terminal device. A codeword corresponds to a precoding matrix. The RI and the PMI as a whole may indicate a layer number and a precoding matrix that are recommended by a UE.

The terminal device may perform downlink channel estimation/measurement according to a CSI-RS to acquire a channel matrix. In codebook-based precoding, the terminal device may select from a codebook, according to a certain optimization criterion, a precoding matrix that best matches a channel matrix, and feed back an index of the precoding matrix to the network device through a feedback link. Meanwhile, in the case where a PMI recommended is to be used, the terminal device can calculate channel quality according to the PMI and report a CQI. In a process of calculating a PMI and a CQI, the terminal device needs to take into account its own reception processing algorithm.

During downlink transmission, the network device precodes data by using a PMI reported by the terminal device as a reference. In the case where a precoding matrix used by the network device for downlink is not consistent with the PMI reported by the terminal device, in order to ensure that the terminal device can be informed of an equivalent channel obtained after precoding to demodulate downlink data coherently, the network device needs to indicate via downlink control information (DCI) the precoding matrix used by the network device.

It may be noted that both the layer number and the precoding matrix recommended (or selected) by the terminal device reflect eigen vectors of the channel matrix. Therefore, the terminal device can derive the layer number and the precoding matrix from the channel matrix.

### 3. CSI Feedback and Artificial Intelligence (AI)

In the evolution of wireless communication systems, people are always exploring use of convergence between AI and physical layers. AI may include machine learning (ML), deep learning (DL), etc. Introduction of AI in physical layer algorithms can solve some problems that are difficult to be solved with conventional modeling approaches, such as some nonlinear problems, too complex parameters, etc. With AI algorithms, conventional modeling approaches can be bypassed, and some problem solving patterns can be established through a large amount of data training. With the maturity of AI algorithms and the maturity of hardware suitable for AI algorithms, introduction of AI in physical layer algorithms has attracted more and more attention.

As a typical application, AI may be introduced to CSI feedback. In a scenario where AI is introduced to CSI feedback, a terminal device can directly feed back (or report) a precoding matrix or directly feed back a channel matrix through an AI neural network (“AI model” for short), so as to replace codebook-based feedback. The AI model may include a convolutional neural network (CNN), a deep neural network (DNN), etc.

In some scenarios, compared with codebook-based feedback, direct feedback of a precoding matrix or a channel matrix can provide more information such as magnitude information (an eigen vector does not indicate magnitude information), and is more suitable for multi-user multi-input multi-output (MU-MIMO). After introduction of direct feedback of a precoding matrix or a channel matrix to a CSI feedback framework (an overall feedback mechanism including a CQI, a PMI, an RI, a CRI (or SSBRI), etc.), the terminal device no longer adopts codebook-based feedback, and thus there may be a certain impact on the CSI feedback framework. How to cope with the impact has become an urgent problem to be solved.

The following describes in detail CQI calculation of embodiments of the disclosure with reference to the accompanying drawings.

As illustrated in FIG. 2, which is a schematic flow chart illustrating a method for CQI calculation in embodiments of the disclosure, the method includes the following.
S210, a terminal device calculates a CQI.

Correspondingly, as illustrated in FIG. 3, which is a schematic flow chart illustrating a method for CQI acquisition in embodiments of the disclosure, the method includes the following.
S310, a network device acquires the CQI.

It may be noted that currently, since the CQI is associated with a PMI, an RI, and a CRI (or SSBRI), the terminal device needs to calculate the CQI according to a selected (or recommended) PMI, RI, and CRI (or SSBRI), and the network device needs to calculate the CQI according to a PMI, RI, and CRI (or SSBRI) reported by the terminal device through a CSI feedback process.

Specifically, to calculate the CQI, the terminal device needs to select a PMI/RI combination that corresponds to a precoding matrix in a codebook. Under the assumption of the precoding matrix, the terminal device needs to calculate the current signal to interference and noise ratio (SINR) through an estimated channel matrix and an interference-plus-noise covariance matrix (INCM). Since an effect of an equalizer is considered in an SINR calculation manner corresponding to the SINR, the SINR may also be referred to as a post-equalizer SINR, and the equalizer may also be referred to as an MIMO receiver.

Alternatively, under the assumption of the precoding matrix, the terminal device needs to calculate the current SINR through the estimated channel matrix, the INCM, and a decoder. Since effects of the equalizer and the decoder are considered in the SINR calculation manner corresponding to the SINR, the SINR may also be referred to as a post-decoder SINR.

Therefore, the terminal device needs to calculate a CQI according to a selected (or recommended) PMI, RI, and CRI (or SSBRI), where the CQI potentially corresponds to an SINR.

In addition, after the network device acquires the CQI, the network device can derive an SINR. Moreover, during downlink transmission, the network device may select different PMIs and RIs (corresponding to precoding matrixes) and process the SINR, for example, increase or decrease the SINR according to experience, and furthermore, the network device may select a suitable MCS to perform scheduling for the terminal device.

However, unlike the above manners, the scenario where AI is introduced to CSI feedback needs to be analyzed in embodiments of the disclosure. Therefore, the terminal device can directly feed back (or report) a precoding matrix or directly feed back a channel matrix through an AI model, so as to replace codebook-based feedback. Based on this, in the process of directly feeding back a precoding matrix or a channel matrix through an AI model, since the terminal device does not need to feed back a PMI or no PMI associated with a CQI is reported, the terminal device is unable to calculate a CQI according to a PMI, an RI, and a CRI (or SSBRI), and the network device is unable to calculate a CQI according to a PMI, an RI, and a CRI (or SSBRI).

In the process of directly feeding back a precoding matrix or a channel matrix to a CSI feedback architecture through an AI model, the terminal device needs to acquire a precoding matrix or a channel matrix, process (which may be referred to as preprocess) the precoding matrix or the channel matrix, input the processed precoding matrix or channel matrix to an AI model, and output compressed data through the AI model. The compressed information is input to a quantizer and an encoder, and after quantization and encoding, the compressed information subject to quantization and encoding is transmitted over a physical uplink channel (e.g., a physical uplink shared channel (PUSCH) and a physical uplink control channel (PUCCH)) to the network device. Finally, the network device needs to decode and dequantize the compressed data subject to quantization and encoding, input the compressed data to the AI model to output decompressed data, and then process (which may be referred to as post-processing) the decompressed data to acquire the precoding matrix or the channel matrix.

Although the network device can acquire a precoding matrix or a channel matrix fed back directly through an AI model and calculate an SINR through using the channel matrix, the terminal device needs to map the SINR to a CQI for subsequent PDSCH decoding. This is because, according to definition of the CQI, the CQI index may enable the terminal device to receive a PDSCH transport block with a transport block error probability of 0.1. The PDSCH transport block has a modulation format, a target code rate, and a transport block size. The PDSCH transport block corresponds to the CQI index and occupies a CSI reference resource(s). Therefore, the CQI is associated with a performance of a PDSCH decoder selected by the terminal device. The network device can calculate an SINR, but it does not mean that the terminal device does not need to feed back the CQI.

In summary, in embodiments of the disclosure, in the process of directly feeding back a precoding matrix or a channel matrix to a CSI feedback architecture through an AI model, the CQI may be calculated according to at least one of: a precoding matrix or channel matrix fed back directly, a CRI (or SSBRI), or an RI. At the terminal device side, a precoding matrix or a channel matrix is processed, the processed precoding matrix or channel matrix is input to an AI model to be compressed, and then the compressed precoding matrix or channel matrix is subject to quantization and encoding to acquire coded information. At the network device side, the coded information is decoded and dequantized, the coded information subject to decoding and dequantization is input to the AI model to be decompressed, and then the decompressed coded information is processed to acquire the precoding matrix or the channel matrix. The precoding matrix or the channel matrix in the disclosure may be a precoding matrix or channel matrix before compression or a precoding matrix or channel matrix after decompression.

In addition, in embodiments of the disclosure, the CQI may be associated with a beam direction recommended (or selected) by the terminal device, may be associated with a CRI (or SSBRI) recommended (or selected) by the terminal device, may be associated with an RI recommended (or selected) by the terminal device, or may be associated with both an RI and a CRI (or SSBRI) recommended (or selected) by the terminal device, which is not specifically limited herein.

The following describes specifically manners for how to calculate a CQI.

### Manner 1

Specifically, a CQI may be calculated according to a channel matrix.

It may be understood that the terminal device may calculate a CQI according to a channel matrix; or the network device may calculate a CQI according to a reported channel matrix; or the network device acquires a CQI reported by the terminal device, which is not specifically limited herein.

It may be noted that in an MIMO system, a transmitter has m antennas, a receiver has n antennas, a transmitted signal vector for a transmitting terminal is represented as s, and a received signal vector of a signal passing through an MIMO channel may be expressed as: r=Hs+n, where r represents a received signal vector, H represents an m×n channel matrix, and n represents an additive noise vector. After precoding, an MIMO signal model may be expressed as: r=HWs+n, where W represents a precoding matrix.

In the precoding manner, the transmitter can optimize a spatial characteristic of the transmitted signal vector s through precoding according to the channel matrix H, to enable a spatial distribution characteristic of the transmitted signal vector s to match the channel matrix H, and thus the degree of dependence on a receiver algorithm can be effectively reduced and the receiver algorithm can be simplified. In addition, for MU-MIMO, the receiver is unable to perform channel estimation on signals transmitted to other terminal devices, and thus the case that the transmitter performs precoding can effectively suppress multi-user interference. It may be seen that the case that the transmitter knows the channel matrix and processes the channel matrix through using suitable precoding is beneficial for the system.

Meanwhile, in the precoding manner, an equivalent channel matrix (e.g., HW) is determined via both a precoding matrix and a channel matrix, and a channel characteristic is determined via the equivalent channel matrix, and thus a CQI is associated with both a precoding matrix and a channel matrix. Moreover, in some cases, a precoding matrix may be derived from a channel matrix, for example, a precoding matrix is a transformed matrix of the channel matrix, and thus a CQI is mainly associated with a channel matrix. In summary, in embodiments of the disclosure, the terminal device may calculate a CQI according to a channel matrix H and report the CQI to the network device.

In addition, for how to acquire a channel matrix by the terminal device, the terminal device may acquire the channel matrix by performing channel estimation or channel detection via downlink reference information.

For example, the network device may transmit a CSI-RS to the terminal device, and the terminal device may perform downlink channel estimation/measurement on the current channel according to the CSI-RS to acquire a channel matrix, thereby realizing acquisition of the channel matrix via the CSI-RS. That is, the channel matrix may be determined according to the CSI-RS.

In another example, the terminal device may perform downlink channel estimation/measurement on the current channel according to an SSB or a physical broadcast channel demodulation reference signal (PBCH DMRS) to acquire a channel matrix, thereby realizing acquisition of the channel matrix via the SSB or the PBCH DMRS. That is, the channel matrix may be determined according to the SSB or the PBCH DMRS.

In addition, the terminal device may report the channel matrix through a CSI feedback process.

Correspondingly, the network device may acquire the channel matrix through the CSI feedback process.

For example, the terminal device may feed back (or report) the channel matrix H to the network device by carrying the channel matrix H in signaling in the CSI feedback process. The channel matrix H may be information subject to the AI model, quantization, and encoding, and is transmitted to the network device over a physical uplink channel.
1. A CQI is calculated according to a channel matrix.

In some embodiments, a CQI may be calculated according to a first type vector.

It may be noted that in a process of directly feeding back a channel matrix through an AI model, both the terminal device and the network device may agree on a rule that a CQI is calculated according to the first type vector. The rule may be pre-configured, configured by a network, configured through signaling interaction, etc.

On the one hand, the terminal device can directly feed back the first type vector through an AI model, and thus the terminal device can perform feedback or reporting by replacing a PMI or the like with the first type vector to realize calculation of a CQI. On the other hand, the terminal device can calculate a CQI according to the first type vector, and the network device can know that the CQI is calculated by the terminal device according to the first type vector, and thus the network device can derive, according to the channel matrix, an SINR corresponding to the first type vector and an MCS corresponding to the first type vector, thereby performing scheduling for the terminal device through the MCS.
(1) Direct feedback of the first type vector through an AI model

It may be understood that the terminal device acquires a channel matrix and calculates a CQI according to the first type vector. Then, the terminal device may input the first type vector to an AI model to output compressed information corresponding to the first type vector, and input the compressed information to a quantizer and an encoder, and the terminal device transmits the compressed information subject to quantization and encoding to the network device over a physical uplink channel. Finally, the network device decodes and dequantizes the compressed information subject to quantization and encoding, inputs the compressed information to the same AI model to acquire the first type vector, and calculates a CQI according to the first type vector. Therefore, the terminal device can perform feedback or reporting by replacing a PMI or the like with the first type vector to realize calculation of the CQI.
(2) The first type vector may be a right-singular vector of the channel matrix H.

It may be noted that singular value decomposition (SVD) of the channel matrix H may be expressed as: H=UΣV^{T}, where U=[u₁, u₂, . . . , uₘ] represents an m×m orthogonal matrix or an m×m unitary matrix, i.e., satisfies U^{T}U=I, and V=[v₁, v₂, . . . , vₙ] represents an n×n orthogonal matrix or an n×n unitary matrix, i.e., satisfies V^{T}V=I. Each column vector of V may be referred to as a right-singular vector of the channel matrix H. Σ represents an n×n diagonal matrix. Elements on a diagonal line are p=min(m,n) singular values, σ₁, σ₂, . . . , σₚ, from the channel matrix H, which are arranged in a decreasing order, i.e., σ₁>σ₂>. . . >σₚ. The first type vector of the disclosure may be a right-singular vector of a channel matrix. The right-singular vector of the disclosure may be a predefined right-singular vector, a pre-configured right-singular vector, or a strongest right-singular vector. The strongest may refer to strongest power, largest energy, largest reference signal received power (RSRP), or a largest SINR.

Multiple first type vectors of the disclosure may be multiple right-singular vectors of a channel matrix. The multiple right-singular vectors may be multiple predefined right-singular vectors, multiple pre-configured right-singular vectors, or multiple strongest right-singular vectors. The strongest may refer to strongest power, largest energy, largest RSRP, or a largest SINR.
(3) The first type vector may be an eigen vector of a matrix acquired by multiplying a conjugate transpose of the channel matrix by the channel matrix.

It may be noted that in embodiments of the disclosure, an n×n square matrix H^{T}H may be acquired by performing matrix multiplying on the conjugate transpose H^{T} of the channel matrix and the channel matrix H. By performing eigen decomposition on the square matrix H^{T}H, both an eigen value and an eigen vector acquired satisfy: (H^{T}H)vᵢ=λᵢvᵢ, i∈(1, n), where λᵢ represents an eigen value of the square matrix H^{T}H, and vᵢ represents an eigen vector of the square matrix H^{T}H.

As can be seen from H=UΣV^{T}, (H^{T}H)=VΣV^{T}.

Therefore, the eigen vector of H^{T}H also represents the column vector of V above. That is, V may consist of all eigen vectors of H^{T}H, and the eigen vectors of the square matrix H^{T}H may be right-singular vectors of the channel matrix H.

Based on this, the first type vector of the disclosure may be an eigen vector of a matrix acquired by multiplying the conjugate transpose of the channel matrix by the channel matrix, such as an eigen vector vᵢ of the square matrix H^{T}H described above.

An eigen vector of the disclosure may be a predefined eigen vector, a pre-configured eigen vector, or a strongest eigen vector. The strongest may refer to strongest power, largest energy, largest RSRP, or a largest SINR.

Multiple first type vectors of the disclosure may be multiple eigen vectors of the matrix acquired by multiplying the conjugate transpose of the channel matrix by the channel matrix. The multiple eigen vectors may be multiple predefined eigen vectors, multiple pre-configured eigen vectors, or multiple strongest eigen vectors. The strongest may refer to strongest power, largest energy, largest RSRP, or a largest SINR.
(4) The first type vector may be a vector related to a channel matrix.

In this way, the first type vector may be a vector of a transformed matrix of the channel matrix, which is more flexible.
2. A CQI is calculated according to a first type vector.

It may be noted that the “first type vector” herein is consistent with the above illustration, which is not repeated herein.

In some embodiments, a CQI may be calculated according to L first type vectors, where a value of L is an integer greater than or equal to 1.

Both the terminal device and the network device may agree on a rule that a CQI is calculated according to a first type vector, so that the terminal device may recommend a layer number, and the case that the terminal device recommends a CQI related to a layer number may be more favorable for the network device to select a suitable MCS for multilayer transmission. A set of first type vectors may include L first type vectors.

Similarly, the network device may obtain an SINR according to the first type vector in an inverse method, and select a suitable precoding matrix to calculate a corresponding SINR and a corresponding MCS.

It may be noted that in a process of directly feeding back a channel matrix through an AI model, both the terminal device and the network device may agree on a rule that a CQI is calculated according to the L first type vectors. The rule may be pre-configured, configured by a network, configured through signaling interaction, etc.

On the one hand, the terminal device can directly feed back the L first type vectors through an AI model, and thus the terminal device can perform feedback by replacing a PMI or the like with the L first type vectors to realize calculation of a CQI.

On the other hand, the terminal device can calculate a CQI according to the L first type vectors, and the network device can know that the CQI is calculated by the terminal device according to the L first type vectors, and thus the network device can derive a corresponding SINR and a corresponding MCS according to the channel matrix, thereby performing scheduling for the terminal device through the MCS.
(1) Direct feedback of the L first type vectors through an AI model

It may be understood that the terminal device acquires a channel matrix and calculates a CQI according to the Z first type vectors. Then, the terminal device may input the L first type vectors to an AI model to output compressed information corresponding to the L first type vectors, and input the compressed information to a quantizer and an encoder, and the terminal device transmits the compressed information subject to quantization and encoding to the network device over a physical uplink channel. Finally, the network device decodes and dequantizes the compressed information subject to quantization and encoding, inputs the compressed information to the same AI model to acquire the L first type vectors, and calculates a CQI according to the L first type vectors. Therefore, the terminal device can perform feedback or reporting by replacing a PMI or the like with the L first type vectors to realize calculation of the CQI.
(2) The L first type vectors may be L right-singular vectors of the channel matrix H.
(3) The Z first type vectors may be L eigen vectors of the matrix acquired by multiplying the conjugate transpose of the channel matrix by the channel matrix.
(4) The value of L
\textcircled{1} The value of L is determined by a layer number indicated via an RI.

For example, the value of L may be the layer number indicated via the RI.

It may be noted that the terminal device can recommend the layer number to the network device, and the case that the terminal device recommends a CQI related to a layer number may be more favorable for the network device to select a suitable MCS for multilayer transmission. Since the value of L is the layer number indicated via the RI, the terminal device can feed back only the L first type vectors without feedback of the RI, which is beneficial to saving feedback overhead and also beneficial to selecting a suitable MCS for multilayer transmission.
\textcircled{2} The value of L is determined by a layer number indicated by a higher-layer configured parameter.

For example, the value of L may be the layer number indicated by the higher-layer configured parameter.

It may be noted that in order to realize that the network device can select, according to the current network demand/condition, a layer number to be scheduled, the network device can transmit to the terminal device the higher-layer configured parameter to indicate a layer number, and the terminal device can determine, according to the layer number indicated by the higher-layer configured parameter, the number of first type vectors required, i.e., L.

The higher-layer configured parameter may include a codebook restriction parameter.

It may be noted that the codebook restriction parameter may be a higher layer parameter transmitted by the network device, and the codebook restriction parameter may be used to limit a layer number adopted by the terminal device.

In summary, in “manner 1”, the terminal device can configure the CQI and the channel matrix to be in a CSI reporting configuration, so that the CQI and the channel matrix can be reported to the network device through the CSI feedback process, thereby ensuring that the network device can acquire the CQI calculated by the terminal device and the channel matrix detected by the terminal device.

That is, the CQI and the channel matrix can be configured to be in a channel information reporting configuration.

Alternatively, in “manner 1”, the terminal device can configure the CQI and the first type vector to be in the CSI reporting configuration, so that the CQI and the first type vector can be reported to the network device through the CSI feedback process, thereby ensuring that the network device can acquire the CQI calculated by the terminal device and the first type vector detected by the terminal device.

That is, the CQI and the first type vector may be configured to be in the channel information reporting configuration.

### Manner 2

Specifically, a CQI may be calculated according to a channel matrix and a CRI (or SSBRI).

In this way, the CQI is still associated with a beam direction (CRI (or SSBRI)) recommended by the terminal device, which has a relatively good flexibility.

It may be understood that the terminal device may calculate a CQI according to a channel matrix and a CRI (or SSBRI); or the network device may calculate a CQI according to a reported channel matrix and a reported CRI (or SSBRI); or the network device acquires a CQI reported by the terminal device, which is not specifically limited herein.

It may be noted that the channel matrix in “manner 2” is consistent with the illustration in “manner 1” above, which is not repeated herein.
1. A CQI is calculated according to a channel matrix and a CRI (or SSBRI).

In some embodiments, a CQI may be calculated according to a first type vector and a CRI (or SSBRI).

It may be noted that the “first type vector” herein is consistent with the above illustration, which is not repeated herein.

In addition, in a process of directly feeding back a channel matrix through an AI model, both the terminal device and the network device may agree on a rule that a CQI is calculated according to the first type vector and the CRI (or SSBRI). The rule may be pre-configured, configured by a network, configured through signaling interaction, etc.

On the one hand, the terminal device can directly feed back the first type vector through an AI model, and thus the terminal device can perform feedback by replacing a PMI or the like with the first type vector to realize calculation of a CQI.

On the other hand, the terminal device can calculate a CQI according to the first type vector and the CRI (or SSBRI), and the network device can know that the CQI is calculated by the terminal device according to the first type vector and the CRI (or SSBRI), and thus the network device can derive a corresponding SINR and a corresponding MCS according to the channel matrix, thereby performing scheduling for the terminal device through the MCS.

The “first type vector” in “manner 2” is consistent with the illustration in “manner 1” above, which is not repeated herein.

The “direct feedback of the first type vector through the AI model” in “manner 2” is consistent with the illustration in “manner 1” above, which is not repeated herein.
2. A CQI is calculated according to a first type vector and a CRI (or SSBRI).

It may be noted that the “first type vector” herein is consistent with the above illustration, which is not repeated herein.

In some embodiments, a CQI may be calculated according to L first type vectors and a CRI (or SSBRI), where a value of L is an integer greater than or equal to 1.

It may be noted that in a process of directly feeding back a channel matrix through an AI model, both the terminal device and the network device may agree on a rule that a CQI is calculated according to the L first type vectors and the CRI (or SSBRI). The rule may be pre-configured, configured by a network, configured through signaling interaction, etc.

On the one hand, the terminal device can directly feed back the L first type vectors through an AI model, and thus the terminal device can perform feedback by replacing a PMI or the like with the L first type vectors to realize calculation of a CQI.

On the other hand, the terminal device can calculate a CQI according to the L first type vectors and the CRI (or SSBRI), and the network device can know that the CQI is calculated by the terminal device according to the L first type vectors and the CRI (or SSBRI), and thus the network device can derive a corresponding SINR and a corresponding MCS according to the channel matrix, thereby performing scheduling for the terminal device through the MCS.

The “L first type vectors” in “manner 2” are consistent with the illustration in “manner 1” above, which is not repeated herein.

The “value of L” in “manner 2” is consistent with the illustration in “manner 1” above, which is not repeated herein.

In summary, in “manner 2”, the terminal device can configure the CQI, the channel matrix, and the CRI (or SSBRI) to be in a CSI reporting configuration, so that the CQI, the channel matrix, and the CRI (or SSBRI) can be reported to the network device through the CSI feedback process, thereby ensuring that the network device can acquire the CQI calculated by the terminal device and the channel matrix and the CRI (or SSBRI) detected by the terminal device.

That is, the CQI, the channel matrix, and the CRI (or SSBRI) can be configured to be in a channel information reporting configuration.

In summary, in “manner 2”, the terminal device can configure the CQI, the first type vector, and the CRI (or SSBRI) to be in a CSI reporting configuration, so that the CQI, the first type vector, and the CRI (or SSBRI) can be reported to the network device through the CSI feedback process, thereby ensuring that the network device can acquire the CQI calculated by the terminal device and the first type vector and the CRI (or SSBRI) detected by the terminal device.

That is, the CQI, the first type vector, and the CRI (or SSBRI) can be configured to be in the channel information reporting configuration.

### Manner 3

Specifically, a CQI may be calculated according to a channel matrix and an RI.

In this way, the CQI is still associated with a layer number (RI) recommended by the terminal device, which has a relatively good accuracy.

It may be understood that the terminal device may calculate a CQI according to a channel matrix and an RI; or the network device may calculate a CQI according to a reported channel matrix and a reported RI; or the network device acquires a CQI reported by the terminal device, which is not specifically limited herein.

It may be noted that the channel matrix in “manner 3” is consistent with the illustration in “manner 1” above, which is not repeated herein.
1. A CQI is calculated according to a channel matrix and an RI.

In some embodiments, a CQI may be calculated according to a first type vector and an RI.

It may be noted that the “first type vector” herein is consistent with the above illustration, which is not repeated herein.

In addition, in a process of directly feeding back a channel matrix through an AI model, both the terminal device and the network device may agree on a rule that a CQI is calculated according to the first type vector and the RI. The rule may be pre-configured, configured by a network, configured through signaling interaction, etc.

On the one hand, the terminal device can directly feed back the first type vector through an AI model, and thus the terminal device can perform feedback by replacing a PMI or the like with the first type vector to realize calculation of a CQI.

On the other hand, the terminal device can calculate a CQI according to the first type vector and the RI, and the network device can know that the CQI is calculated by the terminal device according to the first type vector and the RI, and thus the network device can derive a corresponding SINR and a corresponding MCS according to the channel matrix, thereby performing scheduling for the terminal device through the MCS.

The “first type vector” in “manner 3” is consistent with the illustration in “manner 1” above, which is not repeated herein.

The “direct feedback of the first type vector through the AI model” in “manner 3” is consistent with the illustration in “manner 1” above, which is not repeated herein.
2. A CQI is calculated according to a first type vector and an RI.

It may be noted that the “first type vector” herein is consistent with the above illustration, which is not repeated herein.

In some embodiments, a CQI may be calculated according to L first type vectors and an RI, where a value of L is an integer greater than or equal to 1.

It may be noted that in a process of directly feeding back a channel matrix through an AI model, both the terminal device and the network device may agree on a rule that a CQI is calculated according to the Z first type vectors and the RI. The rule may be pre-configured, configured by a network, configured through signaling interaction, etc.

On the one hand, the terminal device can directly feed back the L first type vectors through an AI model, and thus the terminal device can perform feedback by replacing a PMI or the like with the L first type vectors to realize calculation of a CQI.

On the other hand, the terminal device can calculate a CQI according to the L first type vectors and the RI, and the network device can know that the CQI is calculated by the terminal device according to the L first type vectors and the RI, and thus the network device can derive a corresponding SINR and a corresponding MCS according to the channel matrix, thereby performing scheduling for the terminal device through the MCS.

The “L first type vectors” in “manner 3” are consistent with the illustration in “manner 1” above, which is not repeated herein.

The “value of L” in “manner 3” is consistent with the illustration in “manner 1” above, which is not repeated herein.

In summary, in “manner 3”, the terminal device can configure the CQI, the channel matrix, and the RI to be in a CSI reporting configuration, so that the CQI, the channel matrix, and the RI can be reported to the network device through the CSI feedback process, thereby ensuring that the network device can acquire the CQI calculated by the terminal device and the channel matrix and the RI detected by the terminal device.

That is, the CQI, the channel matrix, and the RI are configured to be in a channel information reporting configuration.

Alternatively, in “manner 3”, the terminal device can configure the CQI, the first type vector, and the RI to be in a CSI reporting configuration, so that the CQI, the first type vector, and the RI can be reported to the network device through the CSI feedback process, thereby ensuring that the network device can acquire the CQI calculated by the terminal device and the first type vector and the RI detected by the terminal device.

That is, the CQI, the first type vector, and the RI are configured to be in the channel information reporting configuration.

### Manner 4

Specifically, a CQI may be calculated according to a channel matrix, an RI, and a CRI (or SSBRI).

In this way, the CQI is still associated with a beam direction (CRI (or SSBRI)) recommended by the terminal device, which has a relatively good flexibility, and the CQI is still associated with a layer number (RI) recommended by the terminal device, which has a relatively good accuracy.

It may be understood that the terminal device may calculate a CQI according to a channel matrix, an RI, and a CRI (or SSBRI); or the network device may calculate a CQI according to a reported channel matrix, a reported RI, and a reported CRI (or SSBRI); or the network device acquires a CQI reported by the terminal device, which is not specifically limited herein.

It may be noted that the channel matrix in “manner 4” is consistent with the illustration in “manner 1” above, which is not repeated herein.
1. A CQI is calculated according to a channel matrix, an RI, and a CRI (or SSBRI).

In some embodiments, a CQI may be calculated according to a first type vector, an RI, and a CRI (or SSBRI).

It may be noted that the “first type vector” herein is consistent with the above illustration, which is not repeated herein.

In addition, in a process of directly feeding back a channel matrix through an AI model, both the terminal device and the network device may agree on a rule that a CQI is calculated according to the first type vector, the RI, and the CRI (or SSBRI). The rule may be pre-configured, configured by a network, configured through signaling interaction, etc.

On the one hand, the terminal device can directly feed back the first type vector through an AI model, and thus the terminal device can perform feedback by replacing a PMI or the like with the first type vector to realize calculation of a CQI.

On the other hand, the terminal device can calculate a CQI according to the first type vector, the RI, and the CRI (or SSBRI), and the network device can know that the CQI is calculated by the terminal device according to the first type vector, the RI, and the CRI (or SSBRI), and thus the network device can derive a corresponding SINR and a corresponding MCS according to the channel matrix, thereby performing scheduling for the terminal device through the MCS.

The “first type vector” in “manner 4” is consistent with the illustration in “manner 1” above, which is not repeated herein.

The “direct feedback of the first type vector through the AI model” in “manner 4” is consistent with the illustration in “manner 1” above, which is not repeated herein.
2. A CQI is calculated according to a first type vector, an RI, and a CRI (or SSBRI).

It may be noted that the “first type vector” herein is consistent with the above illustration, which is not repeated herein.

In some embodiments, a CQI may be calculated according to L first type vectors, an RI, and a CRI (or SSBRI), where a value of L is an integer greater than or equal to 1.

It may be noted that in a process of directly feeding back a channel matrix through an AI model, both the terminal device and the network device may agree on a rule that a CQI is calculated according to the multiple first type vectors, the RI, and the CRI (or SSBRI) of the channel matrix. The rule may be pre-configured, configured by a network, configured through signaling interaction, etc.

On the one hand, the terminal device can directly feed back the L first type vectors through an AI model, and thus the terminal device can perform feedback by replacing a PMI or the like with the L first type vectors to realize calculation of a CQI.

On the other hand, the terminal device can calculate a CQI according to the L first type vectors, the RI, and the CRI (or SSBRI), and the network device can know that the CQI is calculated by the terminal device according to the L first type vectors, the RI, and the CRI (or SSBRI), and thus the network device can derive a corresponding SINR and a corresponding MCS according to the channel matrix, thereby performing scheduling for the terminal device through the MCS.

The “L first type vectors” in “manner 4” are consistent with the illustration in “manner 1” above, which is not repeated herein.

The “value of L” in “manner 4” is consistent with the illustration in “manner 1” above, which is not repeated herein.

In summary, in “manner 4”, the terminal device can configure the CQI, the channel matrix, the RI, and the CRI (or SSBRI) to be in a CSI reporting configuration, so that the CQI, the channel matrix, the RI, and the CRI (or SSBRI) can be reported to the network device through the CSI feedback process, thereby ensuring that the network device can acquire the CQI calculated by the terminal device and the channel matrix, the RI, and the CRI (or SSBRI) detected by the terminal device.

That is, the CQI, the channel matrix, the RI, and the CRI (or SSBRI) are configured to be in a channel information reporting configuration.

In summary, in “manner 4”, the terminal device can configure the CQI, the first type vector, the RI, and the CRI (or SSBRI) to be in a CSI reporting configuration, so that the CQI, the first type vector, the RI, and the CRI (or SSBRI) can be reported to the network device through the CSI feedback process, thereby ensuring that the network device can acquire the CQI calculated by the terminal device and the first type vector, the RI, and the CRI (or SSBRI) detected by the terminal device.

That is, the CQI, the first type vector, the RI, and the CRI (or SSBRI) are configured to be in the channel information reporting configuration.

The foregoing solutions of embodiments of the disclosure are mainly described from the viewpoint of the method side. It may be understood that, in order to implement the above functions, the terminal device or the network device includes hardware structures and/or software modules for performing the respective functions. Those skilled in the art may readily recognize that, in combination with the units and algorithmic operations of various examples described in the embodiments disclosed herein, the disclosure can be implemented in hardware or a combination of the hardware and computer software. Whether a function is implemented by way of the hardware or hardware driven by the computer software depends on the particular application and design constraints of the technical solution. Those skilled in the art may use different methods to implement the described functions for each particular application, but such implementation may not be considered as beyond the scope of the disclosure.

According to embodiments of the disclosure, functional units may be divided for the terminal device or the network device in accordance with the foregoing method examples. For example, each functional unit may be divided according to each function, and two or more functions may be integrated in one processing unit. The above-mentioned integrated unit can be implemented in the form of hardware or software program modules. It may be noted that the division of units in embodiments of the disclosure is schematic, and is merely a logical function division, and there may be other division manners in actual implementation.

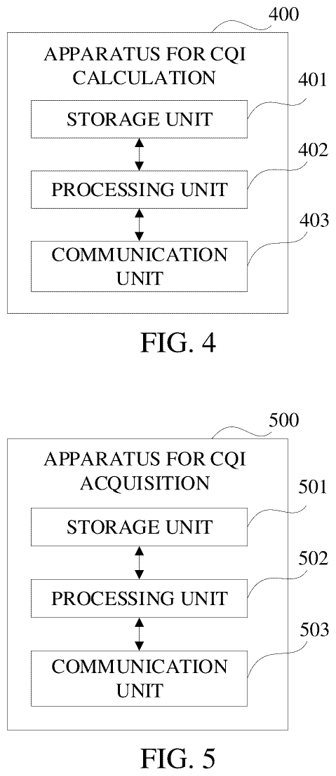

In the case of the integrated unit, FIG. 4 is a block diagram illustrating functional units of an apparatus for CQI calculation in embodiments of the disclosure. The apparatus for CQI calculation 400 includes a processing unit 402 and a communication unit 403. The processing unit 402 is configured to control and manage actions performed by the apparatus for CQI calculation 400. For example, the processing unit 402 is configured to support the apparatus for CQI calculation 400 to perform the operations performed by the terminal device in FIG. 2 and other processes of the technical solutions described in the disclosure. The communication unit 403 is configured to support the apparatus for CQI calculation 400 to communicate with other devices in the wireless communication system. The apparatus for CQI calculation 400 further includes a storage unit 401. The storage unit 401 is configured to computer program codes or instructions executed by the apparatus for CQI calculation 400.

It may be noted that the apparatus for CQI calculation 400 may be a chip or a chip module.

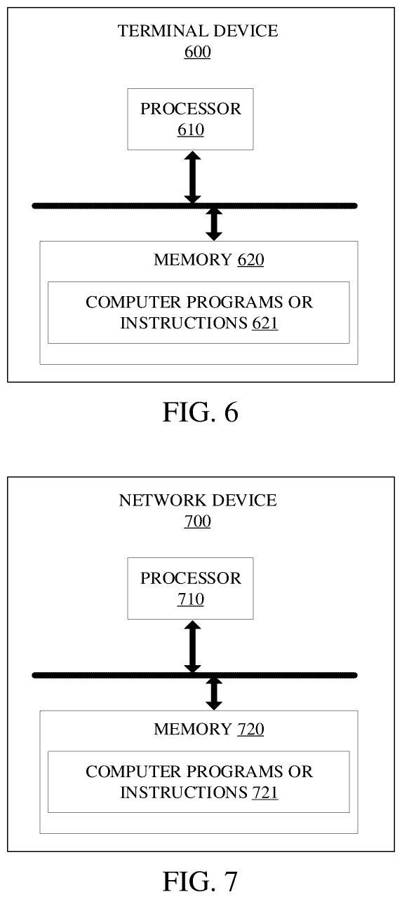

The processing unit 402 may be a processor or a controller, for example, a central processing unit (CPU), a general-purpose processor, a digital signal processor (DSP), an application-specific integrated circuit (ASIC), a field programmable gate array (FPGA), or other programmable logic devices, transistor logic devices, hardware components, or a combination thereof. Various exemplary logic blocks, modules, and circuits disclosed in the disclosure can be implemented or executed. The processing unit 402 may also be a combination for implementing computing functions, for example, a combination of one or more microprocessors, a combination of a DSP and a microprocessor, or the like. The communication unit 403 may be a communication interface, a transceiver, a transceiver circuit, etc. The storage unit 401 may be a memory. In the case where the processing unit 402 is a processor, the communication unit 403 is a communication interface, and the storage unit 401 is a memory, the apparatus for CQI calculation 400 involved in embodiments of the disclosure may be the terminal device illustrated in FIG. 6.

In specific implementation, the processing unit 402 is configured to perform any one operation performed by the terminal device in the above method embodiments, and selectively invoke the communication unit 403 to complete corresponding operations when performing data transmission such as transmission. The following provides detailed description.

The processing unit 402 is configured to calculate a CQI.

It may be noted that for specific implementation of each operation in the embodiments illustrated in FIG. 4, reference can be made to the illustration of the method embodiments illustrated in FIG. 2, which is not repeated herein.

Specifically, the CQI is calculated according to a channel matrix.

Specifically, the CQI is calculated according to the channel matrix as follows. The CQI is calculated according to a first type vector.

Specifically, the CQI is calculated according to the first type vector as follows. The CQI is calculated according to L first type vectors, where a value of L is an integer greater than or equal to 1.

Specifically, the CQI and the channel matrix are configured to be in a CSI reporting configuration; or the CQI and the first type vector are configured to be in the CSI reporting configuration.

Specifically, the CQI is calculated according to a channel matrix and a CRI (or SSBRI).

Specifically, the CQI is calculated according to the channel matrix and the CRI (or SSBRI) as follows. The CQI is calculated according to a first type vector and the CRI (or SSBRI).

Specifically, the CQI is calculated according to the first type vector and the CRI (or SSBRI) as follows. The CQI is calculated according to L first type vectors and the CRI (or SSBRI), where a value of L is an integer greater than or equal to 1.

Specifically, the CQI, the channel matrix, and the CRI (or SSBRI) are configured to be in a CSI reporting configuration; or the CQI, the first type vector, and the CRI (or SSBRI) are configured to be in the CSI reporting configuration.

Specifically, the CQI is calculated according to a channel matrix and an RI.

Specifically, the CQI is calculated according to the channel matrix and the RI as follows. The CQI is calculated according to a first type vector and the RI.

Specifically, the CQI is calculated according to the first type vector and the RI as follows. The CQI is calculated according to L first type vectors and the RI, where a value of Z is an integer greater than or equal to 1.

Specifically, the CQI, the channel matrix, and the RI are configured to be in a CSI reporting configuration; or the CQI, the first type vector, and the RI are configured to be in the CSI reporting configuration.

Specifically, the CQI is calculated according to a channel matrix, an RI, and a CRI (or SSBRI).

Specifically, the CQI is calculated according to the channel matrix, the RI, and the CRI (or SSBRI) as follows. The CQI is calculated according to a first type vector, the RI, and the CRI (or SSBRI).

Specifically, the CQI is calculated according to the first type vector, the RI, and the CRI (or SSBRI) as follows. The CQI is calculated according to L first type vectors, the RI, and the CRI (or SSBRI), where a value of Lis an integer greater than or equal to 1.

Specifically, the CQI, the channel matrix, the RI, and the CRI (or SSBRI) are configured to be in a channel-information reporting configuration; or the CQI, the first type vector, the RI, and the CRI (or SSBRI) are configured to be in the channel-information reporting configuration.

Specifically, the value of L is determined according to a layer number indicated via the RI.

Specifically, the value of L is determined according to a layer number indicated via a higher-layer configured parameter.

Specifically, the higher-layer configured parameter includes a codebook restriction parameter.

Specifically, the first type vector is a right-singular vector of the channel matrix; or the first type vector is a right eigen vector of a matrix acquired by multiplying a conjugate transpose of the channel matrix by the channel matrix.

Specifically, the channel matrix is determined according to a CSI-RS.

Specifically, the processing unit 402 is configured to report the channel matrix through a CSI feedback process.

In the case of the integrated unit, FIG. 5 is a block diagram illustrating functional units of an apparatus for CQI acquisition in embodiments of the disclosure. The apparatus for CQI acquisition 500 includes a processing unit 502 and a communication unit 503. The processing unit 502 is configured to control and manage actions performed by the apparatus for CQI acquisition 500. For example, the processing unit 502 is configured to support the apparatus for CQI acquisition 500 to perform the operations performed by the network device in FIG. 3 and other processes of the technical solutions described in the disclosure. The communication unit 503 is configured to support the apparatus for CQI acquisition 500 to communicate with other devices in the wireless communication system. The apparatus for CQI acquisition 500 further includes a storage unit 501. The storage unit 501 is configured to computer program codes or instructions executed by the apparatus for CQI acquisition 500.

It may be noted that the apparatus for CQI acquisition 500 may be a chip or a chip module.

The processing unit 502 may be a processor or a controller, for example, a CPU, a DSP, an ASIC, an FPGA, or other programmable logic devices, transistor logic devices, hardware components, or a combination thereof. Various exemplary logic blocks, modules, and circuits disclosed in the disclosure can be implemented or executed. The processing unit 502 may also be a combination for implementing computing functions, for example, a combination of one or more microprocessors, a combination of a DSP and a microprocessor, or the like. The communication unit 503 may be a communication interface, a transceiver, a transceiver circuit, etc. The storage unit 501 may be a memory. In the case where the processing unit 502 is a processor, the communication unit 503 is a communication interface, and the storage unit 501 is a memory, the apparatus for CQI acquisition 500 involved in embodiments of the disclosure may be the network device illustrated in FIG. 7.

In specific implementation, the processing unit 502 is configured to perform any one operation performed by the network device in the above method embodiments, and selectively invoke the communication unit 503 to complete corresponding operations when performing data transmission such as transmission. The following provides detailed description.

The processing unit 502 is configured to acquire a CQI.

It may be noted that for specific implementation of each operation in the embodiments illustrated in FIG. 5, reference can be made to the illustration of the method embodiments illustrated in FIG. 3, which is not repeated herein.

Specifically, the CQI is calculated according to a channel matrix.

Specifically, the CQI is calculated according to the channel matrix as follows. The CQI is calculated according to a first type vector.

Specifically, the CQI is calculated according to the first type vector as follows. The CQI is calculated according to L first type vectors, where a value of L is an integer greater than or equal to 1.

Specifically, the CQI and the channel matrix are configured to be in a CSI reporting configuration; or the CQI and the first type vector are configured to be in the CSI reporting configuration.

Specifically, the CQI is calculated according to a channel matrix and a CRI (or SSBRI).

Specifically, the CQI is calculated according to the channel matrix and the CRI (or SSBRI) as follows. The CQI is calculated according to a first type vector and the CRI (or SSBRI).

Specifically, the CQI is calculated according to the first type vector and the CRI (or SSBRI) as follows. The CQI is calculated according to Z first type vectors and the CRI (or SSBRI), where a value of L is an integer greater than or equal to 1.

Specifically, the CQI, the channel matrix, and the CRI (or SSBRI) are configured to be in a CSI reporting configuration; or the CQI, the first type vector, and the CRI (or SSBRI) are configured to be in the CSI reporting configuration.

Specifically, the CQI is calculated according to a channel matrix and an RI.

Specifically, the CQI is calculated according to the channel matrix and the RI as follows. The CQI is calculated according to a first type vector and the RI.

Specifically, the CQI is calculated according to the first type vector and the RI as follows. The CQI is calculated according to L first type vectors and the RI, where a value of L is an integer greater than or equal to 1.

Specifically, the CQI, the channel matrix, and the RI are configured to be in a CSI reporting configuration; or the CQI, the first type vector, and the RI are configured to be in the CSI reporting configuration.

Specifically, the CQI is calculated according to a channel matrix, an RI, and a CRI (or SSBRI).

Specifically, the CQI is calculated according to the channel matrix, the RI, and the CRI (or SSBRI) as follows. The CQI is calculated according to a first type vector, the RI, and the CRI (or SSBRI).

Specifically, the CQI is calculated according to the first type vector, the RI, and the CRI (or SSBRI) as follows. The CQI is calculated according to L first type vectors, the RI, and the CRI (or SSBRI), where a value of L is an integer greater than or equal to 1.

Specifically, the CQI, the channel matrix, the RI, and the CRI (or SSBRI) are configured to be in a channel-information reporting configuration; or the CQI, the first type vector, the RI, and the CRI (or SSBRI) are configured to be in the channel-information reporting configuration.

Specifically, the value of L is determined according to a layer number indicated via the RI.

Specifically, the value of L is determined according to a layer number indicated via a higher-layer configured parameter.

Specifically, the higher-layer configured parameter includes a codebook restriction parameter.

Specifically, the first type vector is a right-singular vector of the channel matrix; or the first type vector is a right eigen vector of a matrix acquired by multiplying a conjugate transpose of the channel matrix by the channel matrix.

Specifically, the channel matrix is determined according to a CSI-RS.

Specifically, in terms of acquiring the CQI, the processing unit 502 is specifically configured to acquire the channel matrix through a CSI feedback process.

Refer to FIG. 6, where FIG. 6 is a schematic structural diagram illustrating a terminal device in embodiments of the disclosure. The terminal device 600 includes a processor 610, a memory 620, and a communication bus configured to connect the processor 610 with the memory 620.

The memory 620 includes, but is not limited to, a random access memory (RAM), a read-only memory (ROM), an erasable programmable ROM (EPROM), or a compact disc (CD)-ROM. The memory 620 is configured to store program codes executed by the terminal device 600 and data transmitted by the terminal device 600.

The terminal device 600 may further include a communication interface, where the communication interface is configured to receive and transmit data.

The processor 610 may be one or more CPUs. In the case where the processor 610 is a CPU, the CPU may be implemented as a single-core CPU or multi-core CPU.

The processor 610 of the terminal device 600 is configured to execute computer programs or instructions 621 stored in the memory 620 to calculate a CQI.

It may be noted that for specific implementation of each operation, reference can be made to the corresponding illustration of the above method embodiments illustrated in FIG. 2. The terminal device 600 may be configured to perform the method at the terminal device side in the above method embodiments of the disclosure, which is not specifically repeated.

Refer to FIG. 7, where FIG. 7 is a schematic structural diagram illustrating a network device in embodiments of the disclosure. The network device 700 includes a processor 710, a memory 720, and a communication bus configured to connect the processor 710 with the memory 720.

The memory 720 includes, but is not limited to, an RAM, an ROM, an EPROM, or a CD-ROM. The memory 720 is configured to store related instructions and data.

The network device 700 may further include a communication interface, where the communication interface is configured to receive and transmit data.

The processor 710 may be one or more CPUs. In the case where the processor 710 is a CPU, the CPU may be implemented as a single-core CPU or multi-core CPU.

The processor 710 of the network device 700 is configured to execute computer programs or instructions 721 stored in the memory 720 to acquire a CQI.

It may be noted that for specific implementation of each operation, reference can be made to the corresponding illustration of the above method embodiments illustrated in FIG. 2. The network device 700 may be configured to perform the method at the network device side in the above method embodiments of the disclosure, which is not specifically repeated.

A computer-readable storage medium is further provided in embodiments of the disclosure. The computer-readable storage medium is configured to store computer programs or instructions. The computer programs or instructions are executed by a processor to implement the operations described in the above method embodiments.

A computer program product is further provided in embodiments of the disclosure. The computer program product includes computer programs or instructions. The computer programs or instructions are executed by a processor to implement the operations described in the above method embodiments. The computer program product may be a software installation package.

It may be noted that, for the sake of simplicity, various embodiments above are described as a series of action combinations. However, it will be appreciated by those skilled in the art that the disclosure is not limited by the sequence of actions described. Some operations in embodiments of the disclosure may be performed in other orders or simultaneously. In addition, it will be appreciated by those skilled in the art that the embodiments described in the specification are preferable embodiments, and the actions, the operations, the modules, and the units involved are not necessarily essential to the disclosure.

In the foregoing embodiments, the description of each embodiment has its own emphasis. For the parts not described in detail in one embodiment, reference may be made to related illustrations in other embodiments.

Those skilled in the art will appreciate that, all or part of the methods, the operations, or functions of relevant modules/units described in embodiments of the disclosure can be implemented through software, hardware, firmware, or any other combination thereof. When implemented by software, all or part of the functions can be implemented in the form of a computer program product or can be implemented by executing computer program instructions by the processor. The computer program product includes at least one computer program instruction. The computer program instructions may consist of corresponding software modules, where the software module may be stored in an RAM, a flash memory, an ROM, an EPROM, an electrically EPROM (EEPROM), a register, a hard disk, a mobile hard disk, a CD-ROM, or any other form of storage medium known in the art. The computer program instructions can be stored in a computer-readable storage medium, or transmitted from one computer-readable storage medium to another computer-readable storage medium. For example, the computer program instructions can be transmitted from one website, computer, server, or data center to another website, computer, server, or data center in a wired manner or in a wireless manner. The computer-readable storage medium can be any computer accessible usable-medium or a data storage device such as a server, a data center, or the like which integrates one or more usable media. The usable medium can be a magnetic medium (such as a soft disk, a hard disk, or a magnetic tape), an optical medium, or a semiconductor medium (such as a solid state disk (SSD)), etc.

Each module/unit in the apparatus or product above described in the above embodiments may be a software module/unit, a hardware module/unit, or may be partially a software module/unit and partially a hardware module/unit. For example, for each apparatus and product applied to or integrated into the chip, each module/unit included can be implemented by hardware such as circuits, or part of modules/units included can be implemented by software programs that run on a processor integrated into the chip, and another part (if existing) of modules/units included can be implemented by hardware such as circuits. Similar, for each apparatus and product applied to or integrated into the chip module or each apparatus and product applied to or integrated into the terminal device, reference can be made to the above.

The embodiments described above describe in further detail purposes, technical solutions and advantages of the embodiments of the disclosure. It may be understood that, the above is only specific embodiments of embodiments of the disclosure, and are not used to limit the protection scope of embodiments of the disclosure. Any modification, equivalent substitution, improvement, and the like that is made on the basis of technical solutions of embodiments of the disclosure shall be included in the protection scope of embodiments of the disclosure.

1. A method for channel quality indicator (CQI) calculation, comprising:
calculating a CQI.

2. The method of claim 1, wherein the CQI is calculated according to a channel matrix.

3. The method of claim 1, wherein the CQI is calculated according to a first type vector.

4. The method of claim 3, wherein the case that the CQI is calculated according to the first type vector comprises:
calculating the CQI according to L first type vectors, wherein a value of L is an integer greater than or equal to 1.

5. (canceled)

6. The method of claim 1, wherein the CQI is calculated according to a channel matrix and a CSI reference signal resource indicator (CRI).

7. The method of claim 1, wherein the CQI is calculated according to a first type vector and a CRI.

8. The method of claim 7, wherein the case that the CQI is calculated according to the first type vector and the CRI comprises:
calculating the CQI according to L first type vectors and the CRI, wherein a value of L is an integer greater than or equal to 1.

9. (canceled)

10. The method of claim 1, wherein the CQI is calculated according to a channel matrix and a rank indicator (RI).

11. The method of claim 1, wherein the CQI is calculated according to a first type vector and an RI.

12. The method of claim 11, wherein the case that the CQI is calculated according to the first type vector and the RI comprises:
calculating the CQI according to L first type vectors and the RI, wherein a value of L is an integer greater than or equal to 1.

13. (canceled)

14. The method of claim 1, wherein the CQI is calculated according to a channel matrix, an RI, and a CRI.

15. The method of claim 1, wherein the CQI is calculated according to a first type vector, an RI, and a CRI.

16. The method of claim 15, wherein the case that the CQI is calculated according to the first type vector, the RI, and the CRI comprises:
calculating the CQI according to Z first type vectors, the RI, and the CRI, wherein a value of L is an integer greater than or equal to 1.

17-20. (canceled)

21. The method of claim 3, wherein the first type vector is a right-singular vector of the channel matrix; or
the first type vector is a right eigen vector of a matrix acquired by multiplying a conjugate transpose of the channel matrix by the channel matrix.

22. (canceled)

23. The method of claim 2, further comprising:
reporting the channel matrix through a CSI feedback process.

24-36. (canceled)

37. The method of claim 241, wherein the CQI is calculated according to a channel matrix, an RI, and a CRI.

38. The method of claim 1, wherein the CQI is calculated according to a first type vector, an RI, and a CRI.

39. The method of claim 38, wherein the case that the CQI is calculated according to the first type vector, the RI, and the CRI comprises:
calculating the CQI according to L first type vectors, the RI, and the CRI, wherein a value of L is an integer greater than or equal to 1.

40-46. (canceled)

47. A terminal device, comprising:
a transcevier;
a processor coupled to the transceiver; and
a memory storing a computer program which, when executed by the processor, causes the terminal device to:
calculate a channel quality indicator CQI.

48-69. (canceled)

70. A network device, comprising:
a transcevier;
a processor coupled to the transceiver; and
a memory storing a computer program which, when executed by the processor, causes the network device to:
acquire a channel quality indicator (CQI) via the transceiver.

71-96. (canceled)
